(19) United States
(12) Patent Application Publication
(10) Pub. No.: US 2010/0124658 A1
(43) Pub. Date: May 20, 2010

(54) METHOD FOR SYNTHESIZING PHOSPHORESCENT OXIDE NANOPARTICLES

(75) Inventors: Yiguang Ju, Pennington, NJ (US); Takeshi Yokomori, Plainsboro, NJ (US); Xiao Qin, Hillsborough, NJ (US)

Correspondence Address: FOX ROTHSCHILD LLP;PRINCETON PIKE CORPORATE CENTER, 997 LENOX DRIVE, BLDG. #3, LAWRENCEVILLE, NJ, 08648, US

(73) Assignee: TRUSTEES OF PRINCETON UNIVERSITY, Princeton, NJ (US)

(21) Appl. No.: 11/537,159

(22) Filed: Sep. 29, 2006

Related U.S. Application Data
(60) Provisional application No. 60/721,917, filed on Sep. 29, 2005.

(51) Int. Cl. C09K 11/77

(52) U.S. Cl. 428/402; 977/773

(57) ABSTRACT

A method for producing activated substantially monodisperse, phosphorescent oxide particles with rare earth element dopants uniformly dispersed therein by mixing a rare earth element dopant precursor powder with an oxide-forming host metal powder to form a solid-phase precursor composition; vaporizing the solid-phase precursor composition; combining the vaporized precursor with an inert carrier gas; contacting the inert carrier gas and the vaporized precursor with a flame fueled by a reactive gas; and uniformly heating the vaporized precursor in the flame to a reaction temperature sufficient to form activated phosphorescent oxide nanoparticles.

### CROSS-REFERENCE TO RELATED APPLICATIONS

This application claims priority to U.S. Provisional Application Ser. No. 60/721,917, which was filed on Sep. 29, 2005, the disclosure of which is incorporated herein by reference.

### BACKGROUND OF THE INVENTION

In recent years nanoparticle technology has become a research focus as its fundamental and practical importance becomes more widely known, especially in the case of luminescent materials. For example, phosphorous nanoparticles, such as doped phosphorescent oxide salt particles, exhibit unique chemical and physical properties when compared with their bulk materials, their properties being halfway between molecular and bulk solid state structures. An example would be quantum confinement effects, which brings electrons to higher energy levels, leading to novel optoelectronic properties. Nanoparticles are also finding use in optical, electrical, biological, chemical, medical and mechanical applications and can be found in television sets, computer screens, fluorescent lamps, lasers, etc.

Various methods such as, thermal hydrolysis, laser heat evaporation, chemical vapor synthesis, microemulsion spray pyrolysis, and pool flame synthesis have been used to prepare “nano-sized” oxide salt particles or phosphors. However, these methods generally require high temperatures, long processing times, repeated milling, the addition of flux, or washing with chemicals, to obtain the desired multi-component oxide particle.

Low temperature methods, such as sol-gel and homogenous precipitation, have also been used to synthesize phosphors, such as, for example, yttrium silicate phosphors. However, there are drawbacks with these methods as well. For example, yttrium silicate powders synthesized using sol-gel techniques have low crystallinity and require post-treatment or annealing at high temperature to crystallize. In low temperature synthesis, an annealing step at a temperature of from about 927 degrees Celsius (° C.) to about 1300° C. for about 6 hours or more is required to achieve uniform ion incorporation and increase efficiency. However, the annealing step can increase particle size through agglomeration and also result in contamination.

Additionally, low temperature processes of producing phosphors, especially rare earth doped phosphors, tends to lead to non-uniform ion incorporation, resulting in a quenching limit concentration of between about 5% and about 7%. The non-uniform ion incorporation produces variations in the distance between ions, with some ions so close that ion-ion interactions produce quantum quenching. This increases as ion concentration increases until a concentration is reached above which decreased fluorescence results. This is defined as the quenching limit concentration.

Therefore, a process is needed for producing particles with more uniform ion incorporation having higher quenching limit concentrations.

### SUMMARY OF THE INVENTION

The present invention provides a method for producing activated substantially monodisperse, phosphorescent oxide particles with rare earth element dopants uniformly dispersed therein by mixing a rare earth element dopant precursor powder with an oxide-forming host metal powder to form a solid-phase precursor composition; vaporizing the solid-phase precursor composition; combining the vaporized precursor with an inert carrier gas; contacting the inert carrier gas and the vaporized precursor with a flame fueled by a reactive gas; and uniformly heating the vaporized precursor composition in the flame to a reaction temperature sufficient to form active radicals that accelerate the formation of activated phosphorescent oxide nanoparticles with uniform rare earth ion distribution.

The inventive method makes possible the preparation of activated cubic phase rare earth doped oxide particles on a nano-scale with quenching limit concentrations heretofore unobtained. Therefore, the present invention also provides rare earth doped monodispersed activated phosphorescent oxide nanoparticle wherein the particles have an average particle size between about 5 and 50 nanometers. Preferred nanoparticles have an average particle size between about 10 and about 20 nanometers.

### BRIEF DESCRIPTION OF THE DRAWINGS

FIG. 1 is a schematic representation of a nanoparticle preparation setup;

FIG. 2 is a TEM image of as-prepared Y₂O₃:Yb,Er nanoparticles;

FIG. 3 is a histogram of size distribution of Y₂O₃:Yb,Er nanoparticles;

FIGS. 4a-c are XRD spectra of (a) as-prepared Y₂O₃:8% Yb, 6% Er nanoparticles; (b) 1000° C. annealed Y₂O₃:8% Yb, 6% Er nanoparticles; (c) commercial bulk Y₂O₃:Eu; and

FIG. 5 shows photoluminescence spectra of Y₂O₃:8% Yb, 6% Er nanoparticles.

### DETAILED DESCRIPTION OF THE INVENTION

According to the present invention, a method is provided for the synthesis of rare-earth doped phosphorescent oxide nanoparticles. The method further provides for homogeneous ion distribution through high temperature atomic diffusion.

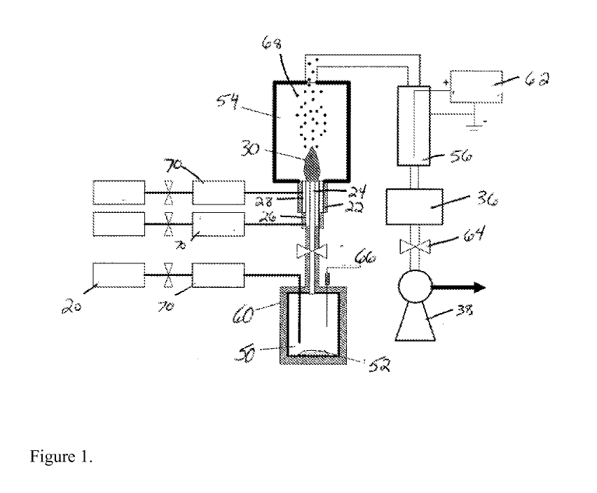

FIG. 1 depicts a flame pyrolysis system consistent with the present invention. The system includes a vaporizing chamber 50 comprising a solid-phase precursor composition 52; a low pressure combustion chamber 54 that houses flame 30; and a particle collection subsystem comprising an electrostatic precipitator 56, a high voltage power supply 62, a cooling system 36, and a vacuum pump 38 for collecting synthesized nanoparticles.

A solid-phase precursor composition (hereinafter referred to as “the precursor composition”) is prepared by mixing one or more rare earth element dopant precursor powders with one or more oxide-forming host metal powders. Stoichiometric amounts of host metal and rare earth element are employed to provide rare earth element doping concentrations in the final particle of at least 0.5 mol % up to the quenching limit concentration.

The present invention provides significant improvement in quenching limit concentrations, depending on the hosts and dopants. For example, the quenching limit concentration is about 15-18 mol % for europium-doped Y₂O₃ nanoparticles, while it is about 10 mol % for erbium-doped Y₂O₃ nanoparticles. Also, for Yb and Er-codoped Y₂O₃ nanoparticles, the quenching limit depends upon the ratio of Yb:Er.

The rare earth element dopant precursor powders include, but are not limited to organometallic rare earth complexes having the structure:

RE(X)₃

wherein X is a trifunctional ligand and RE is a rare earth element. Any rare earth element or combinations thereof can be used (i.e., europium, cerium, terbium, dysprosium, holmium, erbium, thulium, ytterbium, lutetium, etc.) with europium, cerium, terbium, holmium, erbium, thulium and ytterbium being preferred, and the following combinations also being preferred: ytterbium and erbium, ytterbium and holmium and ytterbium and thulium. Strontium can also be used, and for purposes of the present invention, rare earth elements are defined as including strontium. Preferred rare earth element dopant precursor powders include Yb(TMHD)₃, Er(TMHD)₃, Ho(TMHD)₃, Tm(TMHD)₃, erbium isopropoxide (C₉H₂₁O₃Er), ytterbium isopropoxide (C₉H₂₁O₃Yb), and holmium isopropoxide (C₉H₂₁O₃Ho).

Examples of trifunctional ligands include tetramethylheptanedionate (TMHD), isopropoxide (IP), and the like. TMHD is a preferred ligand.

The oxide forming host metal can be, but is not limited to, lanthanum, yttrium, lead, zinc, cadmium, and any of the Group II metals such as, beryllium, magnesium, calcium, strontium, barium, aluminum, radium and any mixtures thereof or a metalloid selected from silicon, germanium and II-IV semi-conductor compounds.

Preferred oxide-forming host metal powders include Y(TMHD)₃, Al(TMHD)₃, Zr(TMHD)₃, Y(IP), and Ti(IP).

The rare earth element dopant precursor powder and oxide-forming host metal powders are mixed in vaporizing chamber 50 to form the precursor composition 52. The vaporizing chamber 50 is heated to a temperature sufficient to vaporize the precursor composition 52. Once the precursor composition is vaporized, an inert carrier gas 20, such as, but not limited to, nitrogen, argon, helium, and mixtures thereof, transports the vaporized precursor composition 58 through a central tube 24 to a low pressure combustion chamber 54 that houses flame 30.

FIG. 1 depicts an embodiment wherein a coflow burner 22 has three concentric tubes 24, 26, and 28. Central tube 24 transports vaporized precursor composition 58 to the low pressure combustion chamber 54, while tubes 26 and 28 co-deliver two reactive gases. In the depicted embodiment, tube 26 delivers methane and tube 28 delivers oxygen. The reactive gas inlets can be any size depending upon the desired gas delivery rate.

A flame produces active atomic oxygen via chain-initiation reaction of

H+O₂=OH+O (i)

A high concentration of oxygen in the flame activates and accelerates the oxidation of rare-earth ions and host materials through a series of reactions:

R+O→RO; (ii)

RO+O→ORO; and (iii)

ORO+RO→R₂O₃ (iv)

Reactions (ii) through (iv) are much faster than the oxidation reaction in low temperature processing represented by the reaction below;

2R+3/2O₂═R₂O₃ (v)

The reaction represented by formula (v) has a much higher energy barrier than the reactions in formulae (i)-(iv) in which radicals formed in flames diffuse and help produce faster ion incorporation.

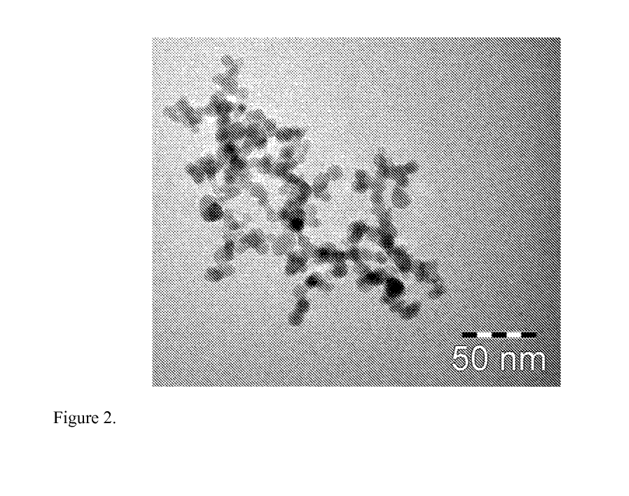

Generally, in flame spray pyrolysis a higher flame temperature increases particle sintering and agglomeration. However, this was not the case in the current work as seen in FIG. 2 wherein spherical, discrete particles are seen. It is proposed that in addition to residence time, the initial size of the vapor-phase particles in the vaporized precursor composition and the precursor itself are the dominant factors that determine final particle size. As the vaporized precursor composition passes through the flame, it directly reacts and releases heat to the flame increasing flame temperature. Thus, a shorter flame residence time is needed, which allows for the production of smaller particles.

Temperatures between about 1800 and about 2900° C. are preferred, with temperatures between about 2200 and about 2400° C. more preferred. Temperatures within this range produce monodispersed rare earth doped activated oxide nanoparticles without significant agglomeration having an essentially uniform distribution of rare earth ions within the particles. Actual residence time will depend upon reactor configuration and volume, as well as the volume per unit time of vaporized precursor composition delivered at a given flame temperature.

Cubic phase particles are obtained having an average particle size between about 5 and about 50 nanometers and preferably between about 10 and about 20 nanometers. Until now, it was not possible to obtain activated cubic phase particles on a nanoscale. The particles also exhibit quenching limit concentrations heretofore unobtained.

The flame temperature can be manipulated by adjusting the flow rates of the gas(es). For example, the temperature of the flame can be increased by increasing the methane flow rate in a methane/oxygen gas mixture. Guided by the present specification, one of ordinary skill in the art will understand without undue experimentation how to adjust the respective flow rates of reactive gas(es) and inert carrier gas to achieve the flame temperature producing the residence time required to obtain an activated particle with a predetermined particle size.

Any reactive gas can be used singularly or in combination to generate the flame for reacting with the vaporized precursor composition, such as, but not limited to, hydrogen, methane, ethane, propane, ethylene, acetylene, propylene, butylenes, n-butane, iso-butane, n-butene, iso-butene, n-pentane, iso-pentane, propene, carbon monoxide, other hydrocarbon fuels, hydrogen sulfide, sulfur dioxide, ammonia, and the like, and mixtures thereof. A hydrogen flame can produce high purity nano-phosphors without hydrocarbon and other material contamination.

In the depicted embodiments, the flame length determines particle residence time within the flame. Higher temperatures produce satisfactory nanoparticles with shorter flames. Flame length is similarly manipulated by varying gas flow rates, which is also well understood by the ordinarily skilled artisan. Increasing the flame length increases the residence time of the particles in the flame allowing more time for the particles to grow. The particle residence time can be controlled by varying the different flow rates of the gases, and is readily understood by one of ordinary skill in the art guided by the present specification.

FIG. 1 shows a particle collection subsystem comprising an electrostatic precipitator 56, a high voltage power supply 62, a cooling system 36, and vacuum pump 38. The electrostatic precipitator 56 is connected to low pressure combustion chamber 54 for gathering the formed nano-phosphor particles 68. Vacuum pump 38 extracts gases and heat from the combustion chamber 54 through cooling system 36. Vacuum pump 38 also provides the force necessary to extract the formed nano-phosphor particles 68 from the combustion chamber 54 onto the electrostatic precipitator 56. A needle valve 64 installed between electrostatic precipitator 56 and vacuum pump 38 provides a means for controlling the pressure in low pressure combustion chamber 54.

Although the particle collection subsystem has been described in a certain embodiment, it is understood that the particle collection subsystem can be designed using any filtering, chilling, or collection system as is known in the art and is not restricted to any particular configuration.

The present invention thus provides a combustion method for the synthesis of phosphor nanoparticles employing vapor-phase precursors from which a broad spectrum of functional nanoparticles can be prepared through broad control of flame temperature, structure and residence time. The following non-limiting examples are merely illustrative of some embodiments of the present invention, and are not to be construed as limiting the invention, the scope of which is defined by the appended claims. All parts and percentages are molar unless otherwise noted and all temperatures are in degrees Celsius.

### EXAMPLES

### Example 1

### Nanoparticle Preparation

An example of a particle preparation system is shown in FIG. 1. The system pressure was kept between atmospheric pressure (approximately 1,013 mbar) and 150 mbar by vacuum pump 38. To protect vacuum pump 38 from heat and contamination with particles and other reaction products, an electrostatic precipitator 56 and cooling system 36 were used.

Rare earth element dopant precursor powders and oxide-forming host metal powders were obtained as white powders from Alfa Aesar (Ward Hill, Mass.) and Sigma-Aldrich (St. Louis, Mo.). Solid-phase precursor composition 52 was prepared by mixing 549.3 mg Y(TMHD)₃ with 57.8 mg Yb(TMHD)₃, 43.0 mg Er(TMHD)₃, in a vaporizing chamber 50. The temperature of chamber 50 was monitored using a thermocouple 66 and was kept constant at about 250° C. by heating with ribbon heater 60 to produce a vaporized precursor. Nanoparticles 68 formed after vaporized precursor 58 was carried into flame 30 in low pressure combustion chamber 54 using argon as the carrier gas. Synthesized nanoparticles were then collected in electrostatic precipitator 56.

To prevent early condensation of the vaporized precursor, the tubes between evaporating chamber 50 and low pressure combustion chamber 54 were also heated by ribbon heater 60. To control the pressure in combustion chamber 54, needle valve 64 was used between electrostatic precipitator 56 and vacuum pump 38. Reactive gases methane and oxygen fueled the flame 30. Mass flow controllers 70 were used to adjust the flow rates of the carrier and reactive gases.

Another example involves mixing 504.6 mg Y(TMHD)₃ with 144.6 mg Yb(TMHD)₃, 7.1 mg Ho(TMHD)₃), in a vaporizing chamber 50 and following the steps outlined above, which results in an oxide with the composition of Y₂O₃: 20% Yb, 1% Ho.

Yet another example involves mixing 600.4 mg Y(TMHD)₃ with 42.1 mg Eu(TMHD)₃, in a vaporizing chamber 50 and following the steps outlined above, which results in an oxide with the composition of Y₂O₃: 6% Eu.

### Example 2

### Particle Analysis

Synthesized nanoparticles are examined by powder X-ray diffractometry (XRD), transmission electron microscope (TEM), and photospectrometry. Powder X-ray diffractometry (XRD, 30 kV and 20 mA, CuKα, Rigaku Miniflex) is used for crystal phase identification and estimation of the crystalline size. The nanoparticle powders are pasted on a quartz glass holder, and the scan is conducted in the range of 10° to 60° (2θ). The morphology and size of particles is examined using a transmission electron microscope (LEO/Zeiss 910 TEM). The photoluminescence spectra of the samples are measured with a Jobin-Yvon Fluorolog-3 fluorometer equipped with a front face detection setup and two double monochromators. The samples are excited at 980 nm with a 150 W Xenon lamp and a 2 nm slit width is used for both monochromators. All samples are examined at room temperature at 25° C.

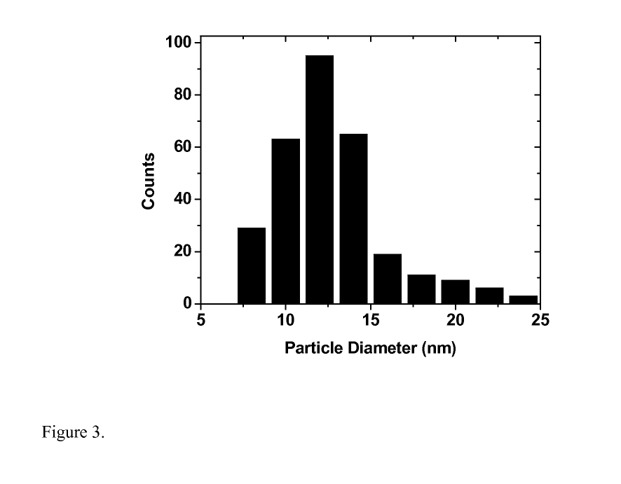

FIG. 2 is a TEM micrograph showing the morphology and size of Y₂O₃:8% Yb, 6% Er nanoparticles prepared at atmospheric pressure. The nanoparticles are weakly agglomerated and have a narrow distribution. FIG. 3 shows the histogram of size distribution, obtained from measuring 300 particles randomly from TEM micrographs. The average diameter of the nanoparticles was 11.8 nm.

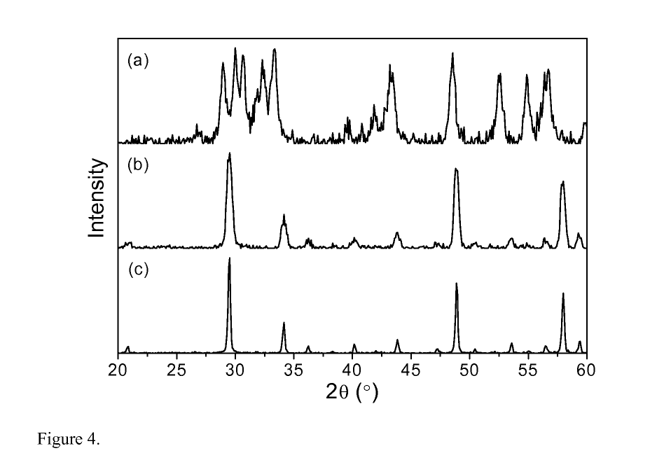

FIG. 4 shows the XRD spectra of the Y₂O₃:8% Yb, 6% Er nanoparticles. The as-prepared nanoparticles (FIG. 4a) show monoclinic crystal structure and the width of the diffraction lines was strongly broadened because of the small size of the crystallites. After annealing at 1000° C. for 2 hours, the crystallites turn into cubic structure (FIG. 4b). The peak positions and intensities of these annealed nanocrystals were similar to those of commercial bulk Y₂O₃:Eu particles (with an average diameter 5 μm).

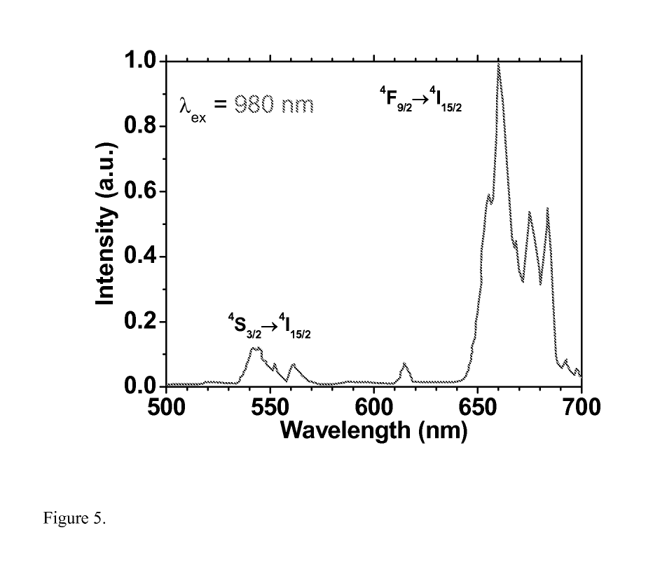

FIG. 5 shows the room-temperature upconversion photoluminescence spectra of the Y₂O₃:8% Yb, 6% Er nanoparticles under 980 nm NIR excitation. There are two emission peaks at 545 and 659 nm, which are assigned to ⁴S_{3/2}→⁴I_{15/2} and ⁴F_{9/2}→⁴I_{15/2} transitions of erbium. The intensity at peak 659 nm is much stronger than that at 545 nm, and the nanoparticles exhibit red emissions to the visible eyes. By varying the ratio of Yb and Er, the relative intensity between green and red emission up-conversion lines will change as discussed by Capobianco et al., J. Phys. Chem. B, vol. 106, p. 1181 (2002). For Y₂O₃:Yb,Ho and Y₂O₃:Yb,Tm nanoparticles, similar spectra line at different peaks and locations were observed.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and script of the invention, and all such variations are intended to be included within the scope of the following claims.

1-13. (canceled)

14. Rare earth doped activated phosphorescent oxide nanoparticles consisting of discrete spherical monoclinic particles with an average particle size between about 5 and about 50 nanometers, wherein said rare earth dopant is selected from the group consisting of europium, cerium, terbium, dysprosium, holmium, erbium, thulium, ytterbium, lutetium and mixtures thereof, and said oxide is selected from the group consisting of lanthanum, yttrium, lead, zinc, cadmium, beryllium, magnesium, calcium, strontium, barium, aluminum and radium oxides and mixtures thereof.

15. (canceled)

16. The nanoparticles of claim 14 wherein said rare earth dopant comprises europium.

17. (canceled)

18. The nanoparticles of claim 14, selected from the group consisting of monoclinic phase Y₂O₃:Yb,Er; Y₂O₃:Yb,Ho; and Y₂O₃:Yb,Tm.
